(19) United States
(12) Patent Application Publication
(10) Pub. No.: US 2025/0393002 A1
(43) Pub. Date: Dec. 25, 2025

(54) METHOD FOR TRIGGERING TIMING ADVANCE REPORTING (TAR), APPARATUS, DEVICE, AND STORAGE MEDIUM

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 18/879,116

(22) PCT Filed: Jun. 28, 2022
(86) PCT No.: PCT/CN2022/102078

§ 371 Date: Dec. 26, 2024

(51) Int. Cl. H04W 56/00; H04W 74/0833

(52) U.S. Cl. CPC H04W 56/003; H04W 74/0833

(57) ABSTRACT

A method for triggering timing advance reporting (TAR) is performed by a terminal device, and includes: in response to a high layer of the terminal device initially configuring or reconfiguring a TA threshold, determining whether the terminal device reports TAR from a specific moment to a current moment; and in response to determining that the terminal device does not report TAR from the specific moment to the current moment, triggering TAR.

### CROSS REFERENCE TO RELATED APPLICATIONS

The present application is a U.S. National Stage of International Application No. PCT/CN2022/102078, filed on Jun. 28, 2022, all contents of which are incorporated herein by reference in their entireties for all purposes.

### TECHNICAL FIELD

The present disclosure relates to the field of communication technology, and in particular, to a method for triggering TAR, an apparatus, a device, and a storage medium.

### BACKGROUND

In a communication system, when a high layer of a terminal device initially configures or reconfigures a timing advance (TA) threshold, if the terminal device does not report timing advance reporting (TAR) before the moment for “initially configuring or reconfiguring the TA threshold”, the terminal device needs to trigger TAR.

### SUMMARY

In a first aspect, according to some embodiments of the present disclosure, there is provided a method for triggering TAR, where the method is performed by a terminal device, and includes:

in response to a high layer of the terminal device initially configuring or reconfiguring a TA threshold, determining whether the terminal device reports TAR from a specific moment to a current moment; and

in response to determining that the terminal device does not report TAR from the specific moment to the current moment, triggering TAR.

In a second aspect, according to some embodiment of the present disclosure, there is provided a method for triggering TAR, where the method is performed by a network device, and includes:

receiving TAR reported by a terminal device, where the TAR is triggered by the terminal device in response to determining that a high layer of the terminal device initially configures or reconfigures a TA threshold and that the terminal device does not report TAR from a specific moment to a current moment.

In a third aspect, according to some embodiment of the present disclosure, there is provided a communication apparatus, where the communication apparatus includes a processor and a memory, the memory stores a computer program, and the processor executes the computer program stored in the memory to cause the communication apparatus to perform the method according to the first aspect.

In a fourth aspect, according to some embodiment of the present disclosure, there is provided a communication apparatus, where the communication apparatus includes a processor and a memory, the memory stores a computer program, and the processor executes the computer program stored in the memory to cause the communication apparatus to perform the method according to the second aspect.

In a fifth aspect, according to some embodiment of the present disclosure, there is provided a communication apparatus including a processor and an interface circuit, where the interface circuit is configured to receive a code instruction and transmit the code instruction to the processor, and the processor is configured to run the code instruction to cause the apparatus to perform the method according to the first aspect.

In a sixth aspect, according to some embodiment of the present disclosure, there is provided a communication apparatus including a processor and an interface circuit, where the interface circuit is configured to receive a code instruction and transmit the code instruction to the processor, and the processor is configured to run the code instruction to cause the apparatus to perform the method according to the second aspect.

In a seventh aspect, according to some embodiment of the present disclosure, there is provided a non-transitory computer-readable storage medium configured for storing an instruction used by the network device and/or the terminal device; when the instruction is executed, the terminal device is caused to perform the method according to the first aspect, and/or, the network device is caused to perform the method according to the second aspect.

### BRIEF DESCRIPTION OF THE DRAWINGS

The above and/or additional aspects and advantages of the present disclosure will become apparent and more readily appreciated from the following descriptions made with reference to the accompanying drawings, in which:

FIG. 1 is a schematic architectural diagram of a communication system provided according to some embodiments of the present disclosure;

FIG. 2a is a schematic flowchart of a method for triggering TAR provided according to some embodiments of the present disclosure;

FIG. 2b is a schematic flowchart of a method for triggering TAR provided according to some embodiments of the present disclosure;

FIG. 2c is a schematic flowchart of a method for triggering TAR provided according to some embodiments of the present disclosure;

FIG. 2d is a schematic flowchart of a method for triggering TAR provided according to some embodiments of the present disclosure;

FIG. 2e is a schematic flowchart of a method for triggering TAR provided according to some embodiments of the present disclosure;

FIG. 2f is a schematic flowchart of a method for triggering TAR provided according to some embodiments of the present disclosure;

FIG. 2g is a schematic flowchart of a method for triggering TAR provided according to some embodiments of the present disclosure;

FIG. 2h is a schematic flowchart of a method for triggering TAR provided according to some embodiments of the present disclosure;

FIG. 2i is a schematic flowchart of a method for triggering TAR provided according to some embodiments of the present disclosure;

FIG. 2j is a schematic flowchart of a method for triggering TAR provided according to some embodiments of the present disclosure;

FIG. 2k is a schematic flowchart of a method for triggering TAR provided according to some embodiments of the present disclosure;

FIG. 3 is a schematic flowchart of a method for triggering TAR provided according to still some embodiments of the present disclosure;

FIG. 4 is a schematic flowchart of a method for triggering TAR provided according to yet some embodiments of the present disclosure;

FIG. 5 is a schematic flowchart of a method for triggering TAR provided according to some embodiments of the present disclosure;

FIG. 6 is a schematic flowchart of a method for triggering TAR provided according to still some embodiments of the present disclosure;

FIG. 7 is a schematic flowchart of a method for triggering TAR provided according to yet some embodiments of the present disclosure;

FIG. 8 is a schematic flowchart of a method for triggering TAR provided according to yet some embodiments of the present disclosure;

FIG. 9 is a schematic flowchart of a method for triggering TAR provided according to yet some embodiments of the present disclosure;

FIG. 10 is a schematic flowchart of a method for triggering TAR provided according to yet some embodiments of the present disclosure;

FIG. 11 is a schematic flowchart of a method for triggering TAR provided according to yet some embodiments of the present disclosure;

FIG. 12 is a schematic flowchart of a method for triggering TAR provided according to yet some embodiments of the present disclosure;

FIG. 13 is a schematic flowchart of a method for triggering TAR provided according to yet some embodiments of the present disclosure;

FIG. 14 is a schematic flowchart of a method for triggering TAR provided according to yet some embodiments of the present disclosure;

FIG. 15 is a schematic flowchart of a method for triggering TAR provided according to yet some embodiments of the present disclosure;

FIG. 16 is a schematic flowchart of a method for triggering TAR provided according to yet some embodiments of the present disclosure;

FIG. 17 is a schematic flowchart of a method for triggering TAR provided according to yet some embodiments of the present disclosure;

FIG. 18 is a schematic flowchart of a method for triggering TAR provided according to yet some embodiments of the present disclosure;

FIG. 19 is a schematic flowchart of a method for triggering TAR provided according to yet some embodiments of the present disclosure;

FIG. 20 is a schematic flowchart of a method for triggering TAR provided according to yet some embodiments of the present disclosure;

FIG. 21 is a schematic flowchart of a method for triggering TAR provided according to yet some embodiments of the present disclosure;

FIG. 22 is a schematic flowchart of a method for triggering TAR provided according to yet some embodiments of the present disclosure;

FIG. 23 is a schematic flowchart of a method for triggering TAR provided according to yet some embodiments of the present disclosure;

FIG. 24 is a schematic structural diagram of a communication apparatus provided according to some embodiments of the present disclosure;

FIG. 25 is a schematic structural diagram of a communication apparatus provided according to some embodiments of the present disclosure;

FIG. 26 is a block diagram of a communication apparatus provided according to some embodiments of the present disclosure;

FIG. 27 is a schematic structural diagram of a chip provided according to some embodiments of the present disclosure.

### DETAILED DESCRIPTION

Example embodiments will be described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. By contrast, they are merely examples of apparatuses and methods consistent with some aspects of the embodiments of the present disclosure as detailed in the appended claims.

Terms used in the embodiments of the present disclosure are merely for the purpose of describing particular embodiments, and are not intended to limit the embodiments of the present disclosure. The singular forms “a” and “the” used in the embodiments of the present disclosure and the appended claims are also intended to include plural forms, unless the context clearly indicates other meanings. It should also be understood that the term “and/or” as used here refers to and includes any or all possible combinations of one or more associated listed items.

It should be understood that although the terms first, second, third, or the like, may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information; and similarly, the second information may also be referred to as first information. Depending on the context, the words “if” and “in case” as used here may be interpreted as “at the time that . . . ” or “when . . . ” or “in response to determining . . . ”.

Embodiments of the present disclosure are described in detail below, and examples of the embodiments are shown in the accompanying drawings, in which the same or similar reference numerals refer to the same or similar elements throughout. The embodiments described below with reference to the drawings are exemplary and are intended to explain the present disclosure and are not to be construed as limitations of the present disclosure.

For ease of understanding, terms involved in the present application are first described.

### 1. Timing Advance (TA) Value

The TA value is used for uplink transmission of a terminal device, and refers that the terminal device sends a data packet at a corresponding time in advance according to a corresponding instruction.

### 2. Preconfigured Uplink Resource (PUR) Procedure

The PUR procedure is mainly applied to an LTE eMTC/NB-IOT terminal device. Among them, the terminal device in a connected state may request the network device to configure a PUR resource for the terminal device; and the network device may determine, based on the request of the terminal device, subscription information of the terminal device, or the local policy, whether to configure the PUR resource for the terminal device. If the network device configures the PUR resource for the terminal device, after the terminal device enters an idle state or an inactive state, if the requirement of timing advance validity is satisfied, and the signal quality change of the serving cell does not exceed a certain threshold, the terminal device may use the PUR resource without initiating a random access procedure.

### 3. Early Data Transmission (EDT) Procedure

The EDT procedure is mainly applied to an LTE eMTC/NB-IOT terminal device, and is directed to a case in which there is only one uplink data packet and a downlink data packet. It allows a terminal device in an idle state or an inactive state to send uplink data or receive downlink data through random access. The preamble used for random access is EDT specific. The terminal device determines whether to use the EDT according to a condition that the size of the uplink data is less than or equal to a small data transmission-transport block size (SDT-TBS), where the SDT-TBS is broadcast to the terminal device through the SIB2 (System information block 2).

### 4. SDT Procedure

The SDT procedure refers to a data transmission procedure that is performed in a random access procedure; that is, a terminal device in a non-connected state (i.e., an idle state or an inactive state) may complete data transmission without performing radio resource control (RRC) state handover. The data transmission in such a random access procedure is small data transmission.

### 5. Timing Advance Reporting (TAR)

The terminal device needs to report TAR to the network device, to cause the network device to know the round trip time (RTT) between UE and a gNB, so that the network device may determine the uplink scheduling occasion or a UL ACK/NACK feedback occasion based on the RTT.

In order to better understand the method for triggering TAR disclosed in the embodiments of the present application, a communication system applicable to the embodiments of the present application is first described below.

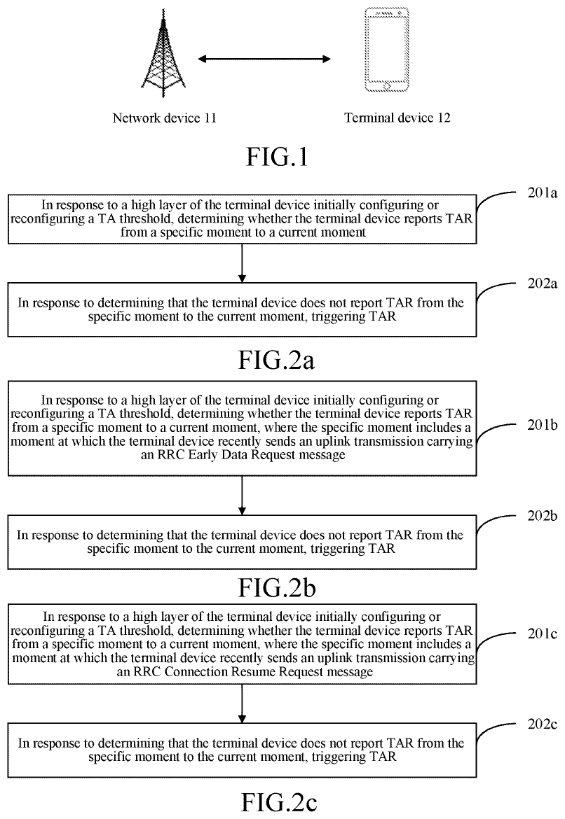

FIG. 1 is a schematic architectural diagram of a communication system provided according to some embodiments of the present disclosure. The communication system may include, but is not limited to, a network device and a terminal device. The number and form of devices shown in FIG. 1 are only used for example, and do not constitute a limitation on the embodiments of the present disclosure. In an actual application, the communication system may include two or more network devices and two or more terminal devices. In the communication system shown in FIG. 1, it takes that one network device 11 and one terminal device 12 are included as an example.

It should be noted that the technical solutions of the embodiments of the present disclosure may be applied to various communication systems, such as a long term evolution (LTE) system, a 5th generation (5G) mobile communication system, a 5G new radio (NR) system, another future new mobile communication system, or the like.

The network device 11 in the embodiments of the present disclosure is an entity for transmitting or receiving a signal on a network side. For example, the network device 11 may be an evolved NodeB (eNB), a transmission reception point (TRP), a next generation NodeB (gNB) in the NR system, a base station in another future mobile communication system, or an access node in a wireless fidelity system. A specific technology and a specific device form used for the network device are not limited in the embodiments of the present disclosure. The network device provided in the embodiments of the present disclosure may be composed of a central unit (CU) and a distributed unit (DU), where the CU may also be referred to as a control unit. The protocol layers for the network device, such as a base station, may be divided by using a CU-DU structure; functions of some protocol layers are placed in the CU for central control; functions of some or all of the remaining protocol layers are distributed in the DU; and the DU is centrally controlled by the CU.

The terminal device 12 in the embodiments of the present disclosure is an entity for receiving or transmitting a signal, such as a mobile phone, on a user side. The terminal device may also be referred to as a terminal, user equipment (UE), a mobile station (MS), a mobile terminal (MT), or the like. The terminal device may be a car with a communication function, a smart car, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in smart home, or the like. A specific technology and a specific device form used for the terminal device are not limited in the embodiments of the present disclosure.

It can be understood that the communication system described in the embodiments of the present disclosure is intended to describe the technical solutions of the embodiments of the present disclosure more clearly, and does not constitute a limitation on the technical solutions provided in the embodiments of the present disclosure. Those of ordinary skill in the art can know that as the evolution of the system architecture and the appearance of the new service scenario, the technical solutions provided in the embodiments of the present disclosure are also applicable to similar technical problems.

In the related art, the meaning of the word “before” is not clearly defined. For example, before the terminal device enters the connected state, a plurality of preconfigured uplink resource (PUR) procedures or early data transmission (EDT) procedures are performed in the current serving cell, and TAR is reported to the current serving cell in each procedure. In the related art, it cannot be determined whether the foregoing “before” needs to be considered for the TAR reported at these moments. That is, the concept of “before” in the related art is not clearly defined, which may result in that the TAP is not successfully triggered.

The method for triggering TAR, apparatus, device, and storage medium provided in the embodiments of the present disclosure are described in detail below with reference to the accompanying drawings.

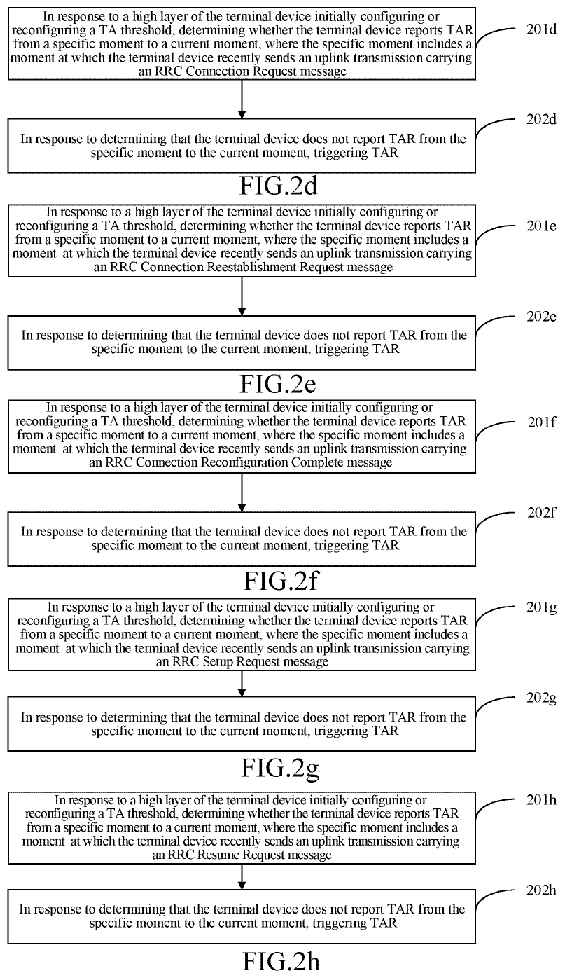

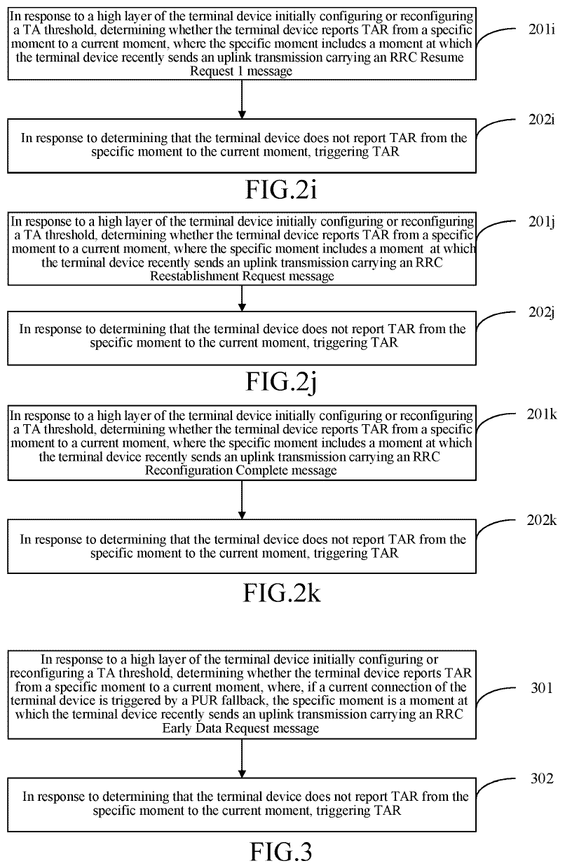

FIG. 2a is a schematic flowchart of a method for triggering TAR provided according to embodiments of the present disclosure, and the method is performed by a terminal device. As shown in FIG. 2a, the method for triggering TAR may include the following steps.

In step 201a, in response to a high layer of the terminal device initially configuring or reconfiguring a TA threshold, it is determined whether the terminal device reports TAR from a specific moment to a current moment.

In some embodiments of the present disclosure, the high layer of the terminal device may be an RRC layer of the terminal device.

In addition, in some embodiments of the present disclosure, the TA threshold is offsetThresholdTA, where the TA threshold may be used for triggering the TAR when the TA change of the terminal device is greater than the TA threshold.

Furthermore, in some embodiments of the present disclosure, the specific moment is specifically a moment that is clearly defined in advance. Among them, in some embodiments of the present disclosure, the specific moment may be a moment at which the terminal device sends any message to the network device in an access procedure of a current connection of the terminal device, where the detailed description about the specific moment will be explained in the following embodiments.

In step 202a, in response to determining that the terminal device does not report TAR from the specific moment to the current moment, TAR is triggered.

In some embodiments of the present disclosure, the terminal device triggering the TAR may specifically include that the terminal device instructs the media access control (MAC) layer to initiate the TAR through the RRC layer.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2b is a schematic flowchart of a method for triggering TAR provided according to embodiments of the present disclosure, and the method is performed by a terminal device. As shown in FIG. 2b, the method for triggering TAR may include the following steps.

In step 201b, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Early Data Request (radio resource control early data request) message.

In some embodiments of the present disclosure, the RRC Early Data Request is specifically a message for triggering a PUR procedure or an EDT procedure by UE in a non-connected state.

In some embodiments of the present disclosure, the method for triggering the EDT procedure through the RRC Early Data Request may be as follows: the terminal device in a non-connected state may send an RRC Early Data Request to the network device through the msg3, where the RRC Early Data Request carries a non-access stratum (NAS) message including UL data (uplink data); and then, the terminal device may receive an RRC Early Data Complete Message sent by the network device through msg4, where the RRC Early Data Complete Message may carry a NAS message including DL Data (downlink data).

In some embodiments of the present disclosure, the method for triggering the PUR procedure through the RRC Early Data Request may be as follows: the terminal device in the non-connected state sends the RRC Early Data Request to the network device through a PUR resource to trigger the PUR procedure, where the RRC Early Data Request carries a NAS message including UL data.

Furthermore, in some embodiments of the present disclosure, the moment for uplink transmission is specifically a start moment of the uplink transmission, that is, a start sending moment of the RRC Early Data Request message.

In step 202b, in response to determining that the terminal device does not report TAR from the specific moment to the current moment, TAR is triggered.

Related descriptions of steps 201b to 202b may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2c is a schematic flowchart of a method for triggering TAR provided according to embodiments of the present disclosure, and the method is performed by a terminal device. As shown in FIG. 2c, the method for triggering TAR may include the following steps.

In step 201c, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Connection Resume Request (radio resource control connection resume request) message.

In some embodiments of the present disclosure, the RRC Connection Resume Request may be a message for triggering a PUR procedure or an EDT procedure by UE in a non-connected state.

In some embodiments of the present disclosure, the method for triggering the EDT procedure through the RRC Connection Resume Request may be as follows: the terminal device in a non-connected state sends the RRC Connection Resume Request message and UL Data to the network device through the msg3, where the UL Data is not in the RRC Connection Resume Request message, but is sent together with the RRC Connection Resume Request message; and then, the terminal device may receive an RRC Connection Release (radio resource control connection release) message and DL Data (downlink data) sent by the network device, where the DL Data is not in the RRC Connection Release message, but is sent together with the RRC Connection Release message, and the RRC Connection Release message may indicate completion of the EDT procedure.

In some embodiments of the present disclosure, the method for triggering the PUR procedure through the RRC Connection Resume Request may be as follows: the terminal device in the non-connected state sends the RRC Connection Resume Request to the network device through the PUR resource to trigger the PUR procedure.

In step 202c, in response to determining that the terminal device does not report TAR from the specific moment to the current moment, TAR is triggered.

Related descriptions of steps 201c to 202c may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2d is a schematic flowchart of a method for triggering TAR provided according to embodiments of the present disclosure, and the method is performed by a terminal device. As shown in FIG. 2d, the method for triggering TAR may include the following steps.

In step 201d, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Connection Request (radio resource control connection request) message.

In step 202d, in response to determining that the terminal device does not report TAR from the specific moment to the current moment, TAR is triggered.

Related descriptions of steps 201d to 202d may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2e is a schematic flowchart of a method for triggering TAR provided according to embodiments of the present disclosure, and the method is performed by a terminal device. As shown in FIG. 2e, the method for triggering TAR may include the following steps.

In step 201e, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Connection Reestablishment Request (radio resource control connection reestablishment request) message.

In step 202e, in response to determining that the terminal device does not report TAR from the specific moment to the current moment, TAR is triggered.

Related descriptions of steps 201e to 202e may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2f is a schematic flowchart of a method for triggering TAR provided according to embodiments of the present disclosure, and the method is performed by a terminal device. As shown in FIG. 2f, the method for triggering TAR may include the following steps.

In step 201f, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Connection Reconfiguration Complete (radio resource control connection reconfiguration complete) message.

In step 202f, in response to determining that the terminal device does not report TAR from the specific moment to the current moment, TAR is triggered.

Related descriptions of steps 201f to 202f may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2g is a schematic flowchart of a method for triggering TAR provided according to embodiments of the present disclosure, and the method is performed by a terminal device. As shown in FIG. 2g, the method for triggering TAR may include the following steps.

In step 201g, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Setup Request (radio resource control setup request) message.

In step 202g, in response to determining that the terminal device does not report TAR from the specific moment to the current moment, TAR is triggered.

Related descriptions of steps 201g to 202g may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2h is a schematic flowchart of a method for triggering TAR provided according to embodiments of the present disclosure, and the method is performed by a terminal device. As shown in FIG. 2h, the method for triggering TAR may include the following steps.

In step 201h, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Resume Request (radio resource control resume request) message.

In step 202h, in response to determining that the terminal device does not report TAR from the specific moment to the current moment, TAR is triggered.

Related descriptions of steps 201h to 202h may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2i is a schematic flowchart of a method for triggering TAR provided according to embodiments of the present disclosure, and the method is performed by a terminal device. As shown in FIG. 2i, the method for triggering TAR may include the following steps.

In step 201i, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Resume Request 1 message.

In step 202i, in response to determining that the terminal device does not report TAR from the specific moment to the current moment, TAR is triggered.

Related descriptions of steps 201i to 202i may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2j is a schematic flowchart of a method for triggering TAR provided according to embodiments of the present disclosure, and the method is performed by a terminal device. As shown in FIG. 2j, the method for triggering TAR may include the following steps.

In step 201j, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Reestablishment Request (radio resource control reestablishment request) message.

In step 202j, in response to determining that the terminal device does not report TAR from the specific moment to the current moment, TAR is triggered.

Related descriptions of steps 201j to 202j may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 2k is a schematic flowchart of a method for triggering TAR provided according to embodiments of the present disclosure, and the method is performed by a terminal device. As shown in FIG. 2k, the method for triggering TAR may include the following steps.

In step 201k, in response to a high layer of the terminal device initially configuring or reconfiguring a TA threshold, it is determined whether the terminal device reports TAR from a specific moment to a current moment, where the specific moment includes a moment at which the terminal device recently sends an uplink transmission carrying an RRC Reconfiguration Complete (radio resource control reconfiguration complete) message.

In step 202k, in response to determining that the terminal device does not report TAR from the specific moment to the current moment, TAR is triggered.

Related descriptions of steps 201k to 202k may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

In addition, it should be noted that the foregoing embodiments of FIG. 2b to FIG. 2f corresponds to embodiments of a long term evolution (LTE) system, and the foregoing embodiments of FIG. 2g to FIG. 2k corresponds to embodiments of a new radio (NR) system.

FIG. 3 is a schematic flowchart of a method for triggering TAR provided according to embodiments of the present disclosure, and the method is performed by a terminal device. As shown in FIG. 3, the method for triggering TAR may include the following steps.

In step 301, in response to a high layer of the terminal device initially configuring or reconfiguring a TA threshold, it is determined whether the terminal device reports TAR from a specific moment to a current moment, where, if a current connection of the terminal device is triggered by a PUR fallback, the specific moment is a moment at which the terminal device recently sends an uplink transmission carrying an RRC Early Data Request message.

Related descriptions about the TA threshold may refer to the descriptions in the foregoing embodiments.

In some embodiments of the present disclosure, the foregoing current connection triggered by the PUR fallback may be understood as that: the terminal device triggers the PUR in the non-connected state; however, due to some reasons, the terminal device may fall from the PUR procedure back to the legacy RRC connection establishment procedure (a traditional RRC connection establishment procedure) through an autonomous request or based on the indication of the network device.

In some embodiments of the present disclosure, for a Cellular Internet of Things (CIOT) based on a control plane performed by using the PUR, the current connection triggered by the PUR fallback may be considered as the following procedure.

The terminal device in the non-connected state sends an RRC Early Data Request to the network device through a PUR resource, so as to trigger a PUR procedure, where the RRC Early Data Request carries an NAS message including UL Data (uplink data). However, after receiving the RRC Early Data Request, if the network device desires to fall back to the legacy RRC connection establishment procedure, there are two manners. In manner 1, the network device sends a Layer 1 fallback indication, and the subsequent behavior of the terminal device depends on the implementation of the terminal device. In manner 1, the network device sends an RRC Connection Setup message to the terminal device. Subsequently, the terminal device may fall back to the legacy RRC connection establishment procedure based on the Layer 1 fallback indication or the RRC Connection Setup message, to perform a random access procedure.

Based on this, in some embodiments of the present disclosure, the specific moment may be a moment at which the terminal device recently sends an uplink transmission carrying an RRC Early Data Request message.

In some embodiments of the present disclosure, the moment for the uplink transmission is specifically a start moment of the uplink transmission, that is, a start sending moment of the RRC Early Data Request message.

In step 302, in response to determining that the terminal device does not report TAR from the specific moment to the current moment, TAR is triggered.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

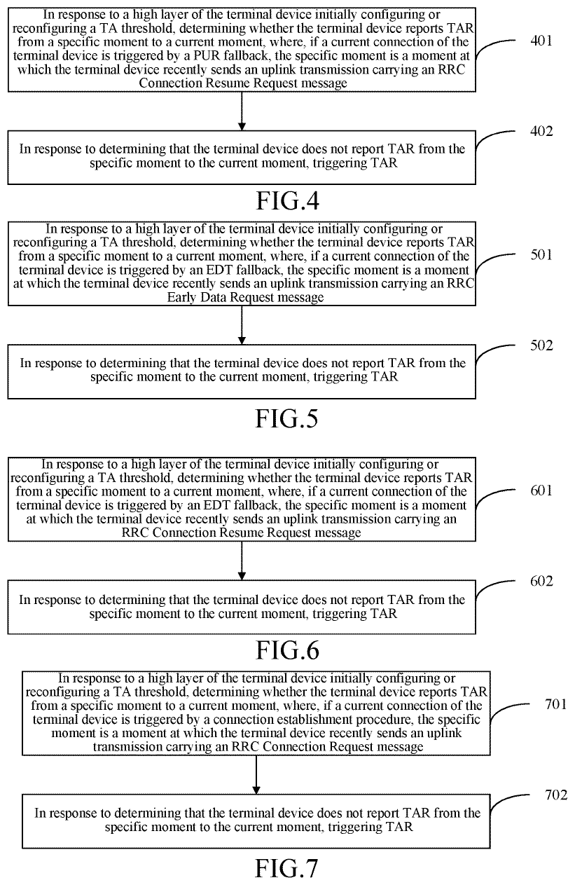

FIG. 4 is a schematic flowchart of a method for triggering TAR provided according to embodiments of the present disclosure, and the method is performed by a terminal device. As shown in FIG. 4, the method for triggering TAR may include the following steps.

In step 401, in response to a high layer of the terminal device initially configuring or reconfiguring a TA threshold, it is determined whether the terminal device reports TAR from a specific moment to a current moment, where, if a current connection of the terminal device is triggered by a PUR fallback, the specific moment is a moment at which the terminal device recently sends an uplink transmission carrying an RRC Connection Resume Request (radio resource control connection resume request) message.

Related descriptions about the TA threshold may refer to the descriptions in the foregoing embodiments.

In some embodiments of the present disclosure, the foregoing current connection triggered by the PUR fallback may be understood as that: the terminal device triggers the PUR in the non-connected state; however, due to some reasons, the terminal device may fall from the PUR procedure back to the legacy RRC connection establishment procedure (a traditional RRC connection establishment procedure) through an autonomous request or based on a indication of the network device.

In some embodiments of the present disclosure, for a CIOT based on a user plane performed by using the PUR, the current connection triggered by the PUR fallback may be considered as the following procedure.

The terminal device in the non-connected state sends an RRC Connection Resume Request to the network device through a PUR resource, so as to trigger a PUR procedure. After receiving the RRC connection resume request, if the network device desires to fall back to the legacy RRC connection establishment procedure, the network device may send an indication to the terminal device. And then, the terminal device may fall back to the legacy RRC connection establishment procedure based on the received indication, to perform a random access procedure.

Based on this, in some embodiments of the present disclosure, the specific moment may be a moment at which the terminal device recently sends an uplink transmission carrying an RRC Connection Resume Request message.

In some embodiments of the present disclosure, the moment for the uplink transmission is specifically a start moment of the uplink transmission, that is, a start sending moment of the RRC Connection Resume Request message.

In step 402, in response to determining that the terminal device does not report TAR from the specific moment to the current moment, TAR is triggered.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 5 is a schematic flowchart of a method for triggering TAR provided according to embodiments of the present disclosure, and the method is performed by a terminal device. As shown in FIG. 5, the method for triggering TAR may include the following steps.

In step 501, in response to a high layer of the terminal device initially configuring or reconfiguring a TA threshold, it is determined whether the terminal device reports TAR from a specific moment to a current moment, where, if a current connection of the terminal device is triggered by an EDT fallback, the specific moment is a moment at which the terminal device recently sends an uplink transmission carrying an RRC Early Data Request message.

Related descriptions about the TA threshold may refer to the descriptions in the foregoing embodiments.

In some embodiments of the present disclosure, the foregoing current connection triggered by the EDT fallback may be understood as that: the terminal device triggers the EDT procedure in the non-connected state; however, due to some reasons, the terminal device may fall from the EDT procedure back to the legacy RRC connection establishment procedure through an autonomous request or based on an indication of the network device.

In some embodiments of the present disclosure, for MO-EDT (mobile originated-EDT) based on a control plane performed by using EDT, the current connection triggered by the EDT fallback may be considered as the following procedure.

The terminal device sends an RRC Early Data Request to the network device through the msg3, where the RRC Early Data Request carries an NAS message including UL Data. And, after receiving the RRC Early Data Request, if the network device desires to fall back to the legacy RRC connection establishment procedure, the network device may send an RRC Connection Setup message to the terminal device. The terminal device may fall back to the legacy RRC connection establishment procedure based on the RRC Connection Setup, to perform random access.

Based on this, in some embodiments of the present disclosure, the specific moment may be a moment at which the terminal device recently sends an uplink transmission carrying an RRC Early Data Request message.

In some embodiments of the present disclosure, the moment for the uplink transmission is specifically a start moment of the uplink transmission, that is, a start sending moment of the RRC Early Data Request message.

In step 502, in response to determining that the terminal device does not report TAR from the specific moment to the current moment, TAR is triggered.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 6 is a schematic flowchart of a method for triggering TAR provided according to embodiments of the present disclosure, and the method is performed by a terminal device. As shown in FIG. 6, the method for triggering TAR may include the following steps.

In step 601, in response to a high layer of the terminal device initially configuring or reconfiguring a TA threshold, it is determined whether the terminal device reports TAR from a specific moment to a current moment, where, if a current connection of the terminal device is triggered by an EDT fallback, the specific moment is a moment at which the terminal device recently sends an uplink transmission carrying an RRC Connection Resume Request message.

Related descriptions about the TA threshold may refer to the descriptions in the foregoing embodiments.

In some embodiments of the present disclosure, the foregoing current connection triggered by the EDT fallback may be understood as that: the terminal device triggers the EDT procedure in the non-connected state; however, due to some reasons, the terminal device may fall from the EDT procedure back to the legacy RRC connection establishment procedure through an autonomous request or based on an indication of the network device.

In some embodiments of the present disclosure, for MO-EDT based on a user plane performed by using EDT, the current connection triggered by the EDT fallback may be considered as the following procedure.

The terminal device sends the RRC Connection Resume Request and the UL data to the network device through the msg3, where, the UL data is not in the RRC Connection Resume Request message, but is sent together with the RRC Connection Resume Request message. And, after receiving the RRC Connection Resume Request, if the network device desires to fall back to the legacy RRC connection establishment procedure, the network device may send an indication to the terminal device. The terminal device may fall back to the legacy RRC connection establishment procedure based on the received indication, to perform random access.

Based on this, in some embodiments of the present disclosure, the specific moment may be a moment at which the terminal device recently sends an uplink transmission carrying an RRC Connection Resume Request message.

In some embodiments of the present disclosure, the moment for the uplink transmission is specifically a start moment of the uplink transmission, that is, a start sending moment of the RRC Connection Resume Request message.

In step 602, in response to determining that the terminal device does not report TAR from the specific moment to the current moment, TAR is triggered.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 7 is a schematic flowchart of a method for triggering TAR provided according to embodiments of the present disclosure, and the method is performed by a terminal device. As shown in FIG. 7, the method for triggering TAR may include the following steps.

In step 701, in response to a high layer of the terminal device initially configuring or reconfiguring a TA threshold, it is determined whether the terminal device reports TAR from a specific moment to a current moment, where, if a current connection of the terminal device is triggered by a connection establishment procedure, the specific moment is a moment at which the terminal device recently sends an uplink transmission carrying an RRC Connection Request (radio resource control connection request) message.

In step 702, in response to determining that the terminal device does not report TAR from the specific moment to the current moment, TAR is triggered.

Detailed descriptions of steps 701 to 702 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

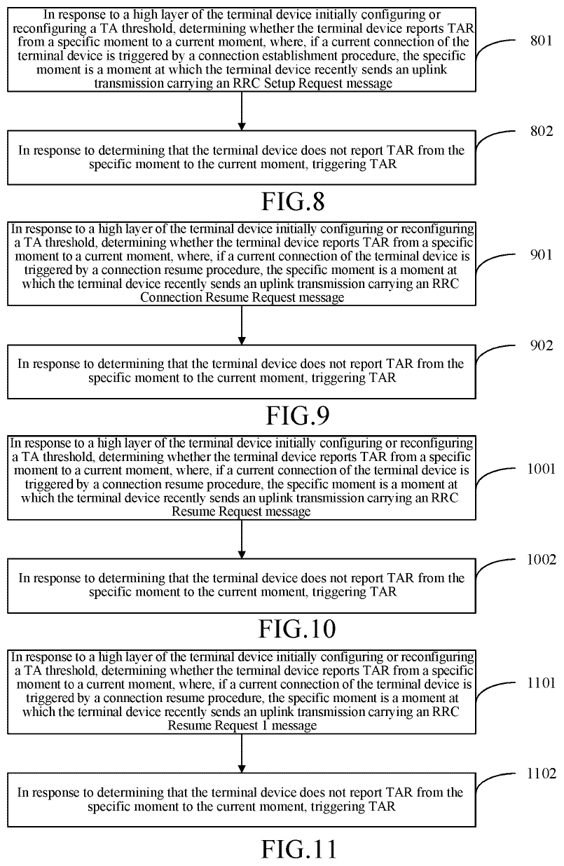

FIG. 8 is a schematic flowchart of a method for triggering TAR provided according to embodiments of the present disclosure, and the method is performed by a terminal device. As shown in FIG. 8, the method for triggering TAR may include the following steps.

In step 801, in response to a high layer of the terminal device initially configuring or reconfiguring a TA threshold, it is determined whether the terminal device reports TAR from a specific moment to a current moment, where, if a current connection of the terminal device is triggered by a connection establishment procedure, the specific moment is a moment at which the terminal device recently sends an uplink transmission carrying an RRC Setup Request message.

In step 802, in response to determining that the terminal device does not report TAR from the specific moment to the current moment, TAR is triggered.

Detailed descriptions of steps 801 to 802 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 9 is a schematic flowchart of a method for triggering TAR provided according to embodiments of the present disclosure, and the method is performed by a terminal device. As shown in FIG. 9, the method for triggering TAR may include the following steps.

In step 901, in response to a high layer of the terminal device initially configuring or reconfiguring a TA threshold, it is determined whether the terminal device reports TAR from a specific moment to a current moment, where, if a current connection of the terminal device is triggered by a connection resume procedure, the specific moment is a moment at which the terminal device recently sends an uplink transmission carrying an RRC Connection Resume Request message.

In step 902, in response to determining that the terminal device does not report TAR from the specific moment to the current moment, TAR is triggered.

Detailed descriptions of steps 901 to 902 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 10 is a schematic flowchart of a method for triggering TAR provided according to embodiments of the present disclosure, and the method is performed by a terminal device. As shown in FIG. 10, the method for triggering TAR may include the following steps.

In step 1001, in response to a high layer of the terminal device initially configuring or reconfiguring a TA threshold, it is determined whether the terminal device reports TAR from a specific moment to a current moment, where, if a current connection of the terminal device is triggered by a connection resume procedure, the specific moment is a moment at which the terminal device recently sends an uplink transmission carrying an RRC Resume Request (radio resource control resume request) message.

In step 1002, in response to determining that the terminal device does not report TAR from the specific moment to the current moment, TAR is triggered.

Detailed descriptions of steps 1001 to 1002 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 11 is a schematic flowchart of a method for triggering TAR provided according to embodiments of the present disclosure, and the method is performed by a terminal device. As shown in FIG. 11, the method for triggering TAR may include the following steps.

In step 1101, in response to a high layer of the terminal device initially configuring or reconfiguring a TA threshold, it is determined whether the terminal device reports TAR from a specific moment to a current moment, where, if a current connection of the terminal device is triggered by a connection resume procedure, the specific moment is a moment at which the terminal device recently sends an uplink transmission carrying an RRC Resume Request I message.

In step 1102, in response to determining that the terminal device does not report TAR from the specific moment to the current moment, TAR is triggered.

Detailed descriptions of steps 1101 to 1102 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

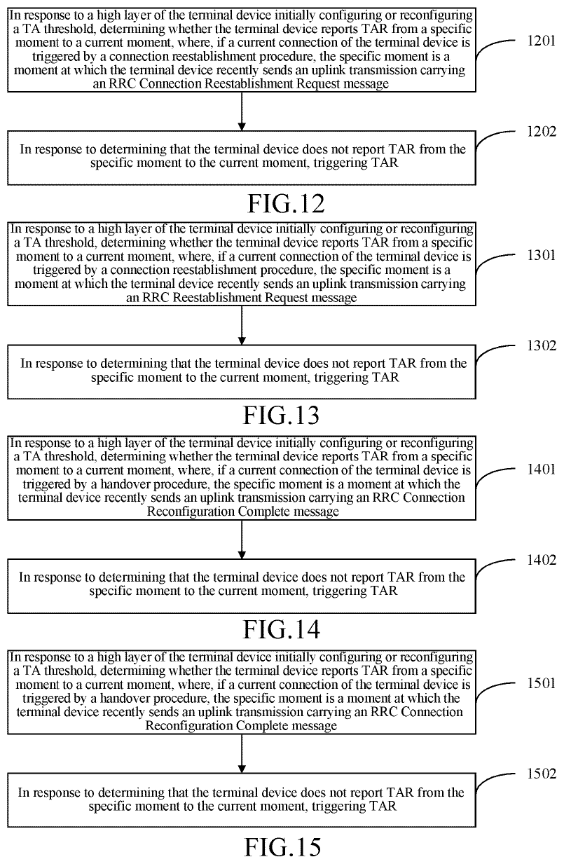

FIG. 12 is a schematic flowchart of a method for triggering TAR provided according to embodiments of the present disclosure, and the method is performed by a terminal device. As shown in FIG. 12, the method for triggering TAR may include the following steps.

In step 1201, in response to a high layer of the terminal device initially configuring or reconfiguring a TA threshold, it is determined whether the terminal device reports TAR from a specific moment to a current moment, where, if a current connection of the terminal device is triggered by a connection reestablishment procedure, the specific moment is a moment at which the terminal device recently sends an uplink transmission carrying an RRC Connection Reestablishment Request (radio resource control connection reestablishment request) message.

In step 1202, in response to determining that the terminal device does not report TAR from the specific moment to the current moment, TAR is triggered.

Detailed descriptions of steps 1201 to 1202 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 13 is a schematic flowchart of a method for triggering TAR provided according to embodiments of the present disclosure, and the method is performed by a terminal device. As shown in FIG. 13, the method for triggering TAR may include the following steps.

In step 1301, in response to a high layer of the terminal device initially configuring or reconfiguring a TA threshold, it is determined whether the terminal device reports TAR from a specific moment to a current moment, where, if a current connection of the terminal device is triggered by a connection reestablishment procedure, the specific moment is a moment at which the terminal device recently sends an uplink transmission carrying an RRC Reestablishment Request (radio resource control reestablishment request) message.

In step 1302, in response to determining that the terminal device does not report TAR from the specific moment to the current moment, TAR is triggered.

Detailed descriptions of steps 1301 to 1302 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 14 is a schematic flowchart of a method for triggering TAR provided according to embodiments of the present disclosure, and the method is performed by a terminal device. As shown in FIG. 14, the method for triggering TAR may include the following steps.

In step 1401, in response to a high layer of the terminal device initially configuring or reconfiguring a TA threshold, it is determined whether the terminal device reports TAR from a specific moment to a current moment, where, if a current connection of the terminal device is triggered by a handover procedure, the specific moment is a moment at which the terminal device recently sends an uplink transmission carrying an RRC Connection Reconfiguration Complete (radio resource control connection reconfiguration complete) message.

In step 1402, in response to determining that the terminal device does not report TAR from the specific moment to the current moment, TAR is triggered.

Detailed descriptions of steps 1401 to 1402 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 15 is a schematic flowchart of a method for triggering TAR provided according to embodiments of the present disclosure, and the method is performed by a terminal device. As shown in FIG. 15, the method for triggering TAR may include the following steps.

In step 1501, in response to a high layer of the terminal device initially configuring or reconfiguring a TA threshold, it is determined whether the terminal device reports TAR from a specific moment to a current moment, where, if a current connection of the terminal device is triggered by a handover procedure, the specific moment is a moment at which the terminal device recently sends an uplink transmission carrying an RRC Reconfiguration Complete (radio resource control reconfiguration complete) message.

In step 1502, in response to determining that the terminal device does not report TAR from the specific moment to the current moment, TAR is triggered.

Detailed descriptions of steps 1501 to 1502 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

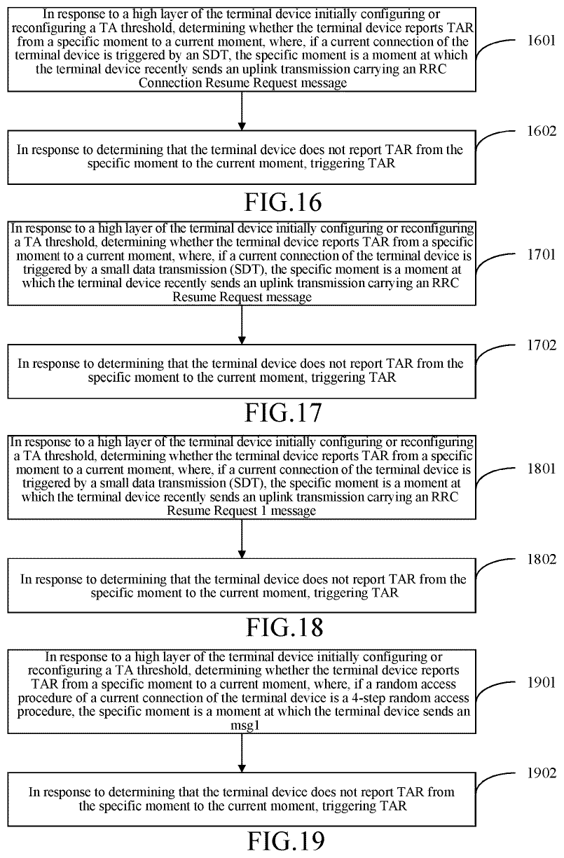

FIG. 16 is a schematic flowchart of a method for triggering TAR provided according to embodiments of the present disclosure, and the method is performed by a terminal device. As shown in FIG. 16, the method for triggering TAR may include the following steps.

In step 1601, in response to a high layer of the terminal device initially configuring or reconfiguring a TA threshold, it is determined whether the terminal device reports TAR from a specific moment to a current moment, where, if a current connection of the terminal device is triggered by an SDT, the specific moment is a moment at which the terminal device recently sends an uplink transmission carrying an RRC Connection Resume Request message.

In step 1602, in response to determining that the terminal device does not report TAR from the specific moment to the current moment, TAR is triggered.

Detailed descriptions of steps 1601 to 1602 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 17 is a schematic flowchart of a method for triggering TAR provided according to embodiments of the present disclosure, and the method is performed by a terminal device. As shown in FIG. 17, the method for triggering TAR may include the following steps.

In step 1701, in response to a high layer of the terminal device initially configuring or reconfiguring a TA threshold, it is determined whether the terminal device reports TAR from a specific moment to a current moment, where, if a current connection of the terminal device is triggered by an SDT, the specific moment is a moment at which the terminal device recently sends an uplink transmission carrying an RRC Resume Request message.

In step 1702, in response to determining that the terminal device does not report TAR from the specific moment to the current moment, TAR is triggered.

Detailed descriptions of steps 1701 to 1702 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 18 is a schematic flowchart of a method for triggering TAR provided according to embodiments of the present disclosure, and the method is performed by a terminal device. As shown in FIG. 18, the method for triggering TAR may include the following steps.

In step 1801, in response to a high layer of the terminal device initially configuring or reconfiguring a TA threshold, it is determined whether the terminal device reports TAR from a specific moment to a current moment, where, if a current connection of the terminal device is triggered by an SDT, the specific moment is a moment at which the terminal device recently sends an uplink transmission carrying an RRC Resume Request 1 message.

In step 1802, in response to determining that the terminal device does not report TAR from the specific moment to the current moment, TAR is triggered.

Detailed descriptions of steps 1801 to 1802 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 19 is a schematic flowchart of a method for triggering TAR provided according to embodiments of the present disclosure, and the method is performed by a terminal device. As shown in FIG. 19, the method for triggering TAR may include the following steps.

In step 1901, in response to a high layer of the terminal device initially configuring or reconfiguring a TA threshold, it is determined whether the terminal device reports TAR from a specific moment to a current moment, where, if a random access procedure of a current connection of the terminal device is a 4-step random access procedure, the specific moment is a moment at which the terminal device sends an msg1.

Among them, in some embodiments of the present disclosure, the above random access procedure may be triggered by any one of the following procedures:

a connection establishment procedure;

a connection resume procedure;

a connection reestablishment procedure;

a PUR procedure;

an EDT procedure;

an SDT procedure based on a random access channel (RACH); or

a handover (HO) procedure requiring for RACH.

In step 1902, in response to determining that the terminal device does not report TAR from the specific moment to the current moment, TAR is triggered.

Detailed descriptions of steps 1901 to 1902 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

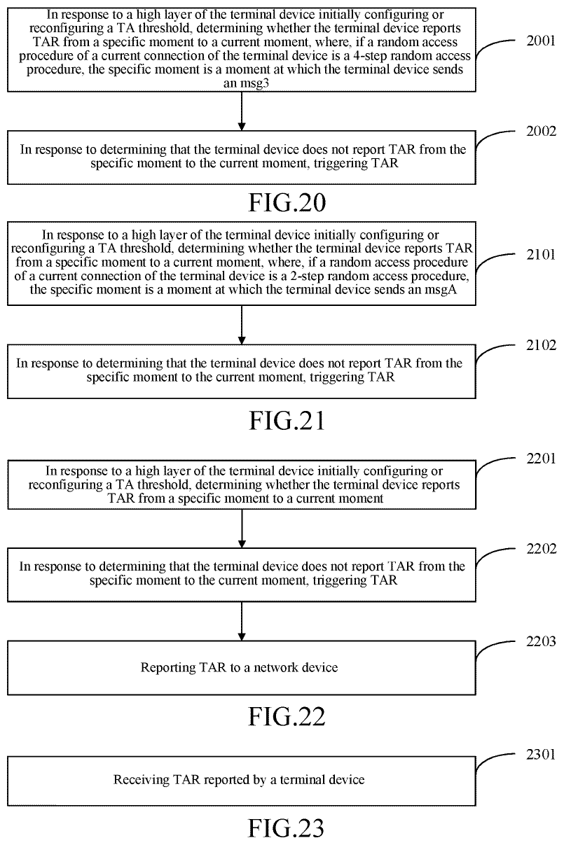

FIG. 20 is a schematic flowchart of a method for triggering TAR provided according to embodiments of the present disclosure, and the method is performed by a terminal device. As shown in FIG. 20, the method for triggering TAR may include the following steps.

In step 2001, in response to a high layer of the terminal device initially configuring or reconfiguring a TA threshold, it is determined whether the terminal device reports TAR from a specific moment to a current moment, where, if a random access procedure of a current connection of the terminal device is a 4-step random access procedure, the specific moment is a moment at which the terminal device sends an msg3.

In step 2002, in response to determining that the terminal device does not report TAR from the specific moment to the current moment, TAR is triggered.

Detailed descriptions of steps 2001 to 2002 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 21 is a schematic flowchart of a method for triggering TAR provided according to embodiments of the present disclosure, and the method is performed by a terminal device. As shown in FIG. 21, the method for triggering TAR may include the following steps.

In step 2101, in response to a high layer of the terminal device initially configuring or reconfiguring a TA threshold, it is determined whether the terminal device reports TAR from a specific moment to a current moment, where, if a random access procedure of a current connection of the terminal device is a 2-step random access procedure, the specific moment is a moment at which the terminal device sends an msgA.

In step 2102, in response to determining that the terminal device does not report TAR from the specific moment to the current moment, TAR is triggered.

Detailed descriptions of steps 2101 to 2102 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 22 is a schematic flowchart of a method for triggering TAR provided according to embodiments of the present disclosure, and the method is performed by a terminal device. As shown in FIG. 22, the method for triggering TAR may include the following steps.

In step 2201, in response to a high layer of the terminal device initially configuring or reconfiguring a TA threshold, it is determined whether the terminal device reports TAR from a specific moment to a current moment.

In step 2202, in response to determining that the terminal device does not report TAR from the specific moment to the current moment, TAR is triggered. In step 2203, TAR is reported to a network device.

Detailed descriptions of steps 2201 to 2203 may refer to the descriptions in the foregoing embodiments.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

FIG. 23 is a schematic flowchart of a method for triggering TAR provided according to embodiments of the present disclosure, and the method is performed by a network device. As shown in FIG. 23, the method for triggering TAR may include the following step.

In step 2301, TAR reported by a terminal device is received.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

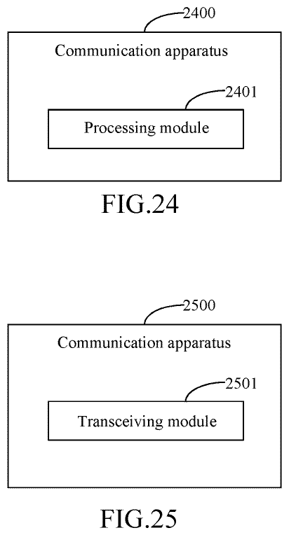

FIG. 24 is a schematic structural diagram of a communication apparatus provided according to embodiments of the present disclosure. As shown in FIG. 24, the communication apparatus 2400 may include a processing module 2401.

The processing module 2401 is configured to, in response to a high layer of a terminal device initially configuring or reconfiguring a TA threshold, determining whether the terminal device reports TAR from a specific moment to a current moment.

The processing module 2401 is further configured to trigger TAR in response to determining that the terminal device does not report TAR from the specific moment to the current moment.

In summary, in the method for triggering TAR provided by the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

In some embodiments of the present disclosure, the specific moment includes at least one of the following:

a moment at which the terminal device recently sends an uplink transmission carrying a radio resource control early data request message;

a moment at which the terminal device recently sends an uplink transmission carrying a radio resource control connection resume request message;

a moment at which the terminal device recently sends an uplink transmission carrying a radio resource control connection request message;

a moment at which the terminal device recently sends an uplink transmission carrying a radio resource control connection reestablishment request message;

a moment at which the terminal device recently sends an uplink transmission carrying a radio resource control connection reconfiguration complete message;

a moment at which the terminal device recently sends an uplink transmission carrying a radio resource control setup request message;

a moment at which the terminal device recently sends an uplink transmission carrying a radio resource control resume request message;

a moment at which the terminal device recently sends an uplink transmission carrying a radio resource control resume request 1 message;

a moment at which the terminal device recently sends an uplink transmission carrying a radio resource control reestablishment request message; or

a moment at which the terminal device recently sends an uplink transmission carrying a radio resource control reconfiguration complete message.

In some embodiments of the present disclosure, the specific moment includes at least one of the following:

if a current connection of the terminal device is triggered by a preconfigured uplink resource (PUR) fallback, the specific moment is a moment at which the terminal device recently sends an uplink transmission carrying a radio resource control early data request message;

if a current connection of the terminal device is triggered by a PUR fallback, the specific moment is a moment at which the terminal device recently sends an uplink transmission carrying a radio resource control connection resume request message;

if a current connection of the terminal device is triggered by an early data transmission (EDT) fallback, the specific moment is a moment at which the terminal device recently sends an uplink transmission carrying a radio resource control early data request message;

if a current connection of the terminal device is triggered by an EDT fallback, the specific moment is a moment at which the terminal device recently sends an uplink transmission carrying a radio resource control connection resume request message;

if a current connection of the terminal device is triggered by a connection establishment procedure, the specific moment is a moment at which the terminal device recently sends an uplink transmission carrying a radio resource control connection request message;

if a current connection of the terminal device is triggered by a connection establishment procedure, the specific moment is a moment at which the terminal device recently sends an uplink transmission carrying a radio resource control setup request message;

if a current connection of the terminal device is triggered by a connection resume procedure, the specific moment is a moment at which the terminal device recently sends an uplink transmission carrying a radio resource control connection resume request message;

if a current connection of the terminal device is triggered by a connection resume procedure, the specific moment is a moment at which the terminal device recently sends an uplink transmission carrying a radio resource control resume request message;

if a current connection of the terminal device is triggered by a connection resume procedure, the specific moment is a moment at which the terminal device recently sends an uplink transmission carrying a radio resource control resume request 1 message;

if a current connection of the terminal device is triggered by a connection reestablishment procedure, the specific moment is a moment at which the terminal device recently sends an uplink transmission carrying a radio resource control connection reestablishment request message;

if a current connection of the terminal device is triggered by a connection reestablishment process, the specific moment is a moment at which the terminal device recently sends an uplink transmission carrying a radio resource control reestablishment request message;

if a current connection of the terminal device is triggered by a handover procedure, the specific moment is a moment at which the terminal device recently sends an uplink transmission carrying a radio resource control connection reconfiguration complete message;

if a current connection of the terminal device is triggered by a handover procedure, the specific moment is a moment at which the terminal device recently sends an uplink transmission carrying a radio resource control reconfiguration complete message;

if a current connection of the terminal device is triggered by a small data transmission (SDT), the specific moment is a moment at which the terminal device recently sends an uplink transmission carrying a radio resource control connection resume request message;

if a current connection of the terminal device is triggered by an SDT, the specific moment is a moment at which the terminal device recently sends an uplink transmission carrying a radio resource control resume request message; or

if a current connection of the terminal device is triggered by an SDT, the specific moment is a moment at which the terminal device recently sends an uplink transmission carrying a radio resource control resume request 1 message.

In some embodiments of the present disclosure, the moment for the uplink transmission is a start moment of the uplink transmission.

In some embodiments of the present disclosure, the specific moment includes at least one of the following:

if a random access procedure of a current connection of the terminal device is a 4-step random access procedure, the specific moment is a moment at which the terminal device sends an msg1; and

if a random access procedure of a current connection of the terminal device is a 4-step random access procedure, the specific moment is a moment at which the terminal device sends an msg3;

if a random access procedure of the current connection of the terminal device is a 2-step random access procedure, the specific moment is a moment at which the terminal device sends an msgA.

In some embodiments of the present disclosure, the apparatus is further configured to:

report the TAR to a network device.

In some embodiments of the present disclosure, the high layer of the terminal device is an RRC layer.

FIG. 25 is a schematic structural diagram of a communication apparatus provided according to embodiments of the present disclosure. As shown in FIG. 25, the communication apparatus 2500 may include a transceiving module 2501.

The transceiving module 2501 is configured to receive TAR reported by a terminal device.

In summary, in the communication apparatus provided by the embodiments of the present disclosure, when the high layer of the terminal device initially configures or reconfigures the TA threshold, the terminal device may determine whether it reports TAR from the specific moment to the current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

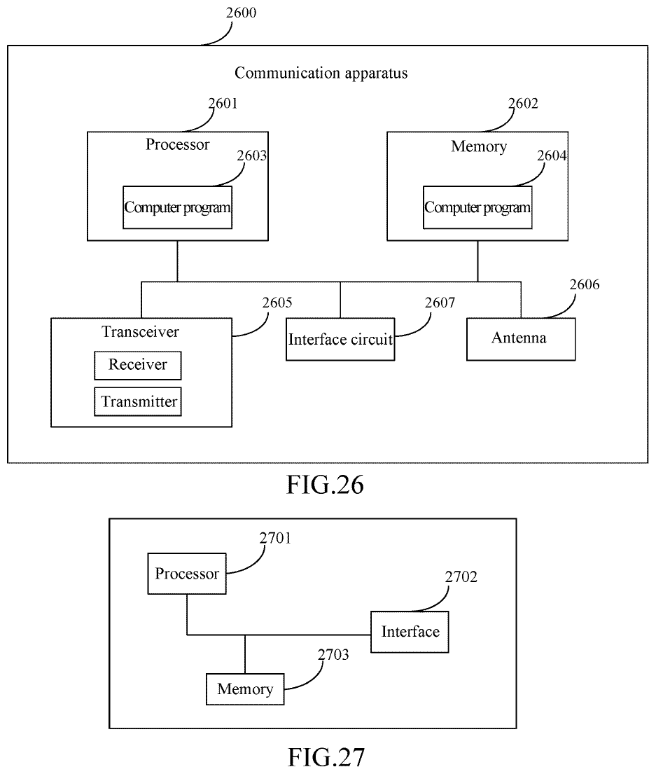

Referring to FIG. 26, FIG. 26 is a schematic structural diagram of a communication apparatus 2600 provided according to embodiments of the present application. The communication apparatus 2600 may be a network device, or a terminal device. The communication apparatus 2600 may be a chip, a chip system, a processor, or the like, that supports the network device to implement the foregoing methods. The communication apparatus 2600 may be a chip, a chip system, a processor, or the like, that supports the terminal device to implement the foregoing methods. The apparatus may be configured to implement the methods described in the foregoing method embodiments, and details may refer to the descriptions in the foregoing method embodiments.

The communication apparatus 2600 may include one or more processors 2601, and the processor 2601 may be a general-purpose processor or a dedicated processor. For example, the processor 2601 may be a baseband processor or a central processor. The baseband processor may be configured to process a communication protocol and communication data. The central processor may be configured to control the communication apparatus (for example, a base station, a baseband chip, a terminal device, a terminal device chip, a DU, or a CU), execute a computer program, and process data of the computer program.

In some embodiments, the communication apparatus 2600 may further include one or more memories 2602, and a computer program 2604 may be stored on the memory 2602. The processor 2601 executes the computer program 2604 to cause the communication apparatus 2600 to perform the method described in the foregoing method embodiments. In some embodiments, the memory 2602 may further store with data. The communication apparatus 2600 and the memory 2602 may be separately disposed, or may be integrated together.

In some embodiments, the communication apparatus 2600 may further include a transceiver 2605, and an antenna 2606. Transceiver 2605 may be referred to as a transceiving unit, a transceiving machine, a transceiving circuit, or the like, and is configured to implement a transceiving function. The transceiver 2605 may include a receiver and a transmitter. The receiver may be referred to as a receiving machine or a receiving circuit, and is configured to implement a receiving function. The transmitter may be referred to as a transmitting machine or a transmitting circuit, and is configured to implement a transmitting function.

In some embodiments, the communication apparatus 2600 may further include one or more interface circuits 2607, where the interface circuit 2607 is configured to receive a code instruction and transmit the code instruction to the processor 2601. The processor 2601 runs the code instruction to cause the communication apparatus 2600 to perform the method described in the foregoing method embodiments.

The communication apparatus 2600 is a network device, where the transceiver 2605 is configured to perform step 2301 in FIG. 23.

The communication apparatus 2600 is a terminal device, where the transceiver 2605 is configured to perform step 2203 in FIG. 22, and the processor 2601 is configured to perform the steps in FIG. 2a to FIG. 21.

In some embodiments, the processor 2601 may include a transceiver configured to implement a receiving and transmitting function. For example, the transceiver may be a transceiving circuit, an interface, or an interface circuit. The transceiving circuit, the interface, or the interface circuit that is configured to implement the receiving and transmitting function may be separate, or may be integrated together. The transceiving circuit, the interface, or the interface circuit may be configured to read/write code/data; or, the transceiver circuit, the interface, or the interface circuit may be configured to transmit or transport a signal.

In some embodiments, the processor 2601 may store with a computer program 2603, and the computer program 2603 runs on the processor 2601 to cause the communication apparatus 2600 to perform the methods described in the foregoing method embodiments. The computer program 2603 may be cured in the processor 2601, and in this case, the processor 2601 may be implemented by hardware.

In some embodiments, the communication apparatus 2600 may include a circuit, and the circuit may implement a function of transmitting or receiving or communicating in the foregoing method embodiments. The processor and the transceiver described in the present application may be implemented on an integrated circuit (IC), an analog IC, a radio frequency integrated circuit (RFIC), a mixed signal IC, an application specific integrated circuit (ASIC), a printed circuit board (PCB), an electronic device, or the like. The processor and the transceiver may also be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), Silicon Germanium (SiGe), Gallium Arsenide (GaAs), etc.

The communication apparatus described in the foregoing embodiments may be a network device or a terminal device, but the scope of the communication apparatus described in the present application is not limited to this, and the structure of the communication apparatus may not be limited by FIG. 26. The communication device may be an independent device or may be a part of a relatively larger device. For example, the communication apparatus may be:
(1) an independent integrated circuit IC, or a chip, or a chip system or subsystem;
(2) a set having one or more ICs, in some embodiments, the IC set may also include a storage component for storing data and a computer program;
(3) an ASIC, such as a modem;
(4) modules that may be embedded in other devices;
(5) a receiver, a terminal device, a smart terminal device, a cellular phone, a wireless device, a handset, a mobile unit, a vehicle-mounted device, a network device, a cloud device, an artificial intelligence device, or the like;
(6) other devices, etc.

For a case that the communication apparatus may be a chip or a chip system, reference may be made to a schematic structural diagram of a chip shown in FIG. 27. The chip shown in FIG. 27 includes a processor 2701 and an interface 2702, where the number of the processor 2701 may be one or more, and the number of the interface 2702 may be more than one.

In some embodiments, the chip further includes a memory 2703, and the memory 2703 is configured to store necessary computer programs and data.

Those skilled in the art may further understand that various illustrative logical blocks and steps listed in the embodiments of the present application may be implemented by electronic hardware, computer software, or a combination of the two. Whether such functions are implemented by hardware or software depends upon the particular application and design requirements of the overall system. Those skilled in the art may use various methods to implement the functions for each particular application, but it should not be understood that the implementation goes beyond the scope of protection of the embodiments of the present application.

According to the present application, there is further provided a non-transitory computer-readable storage medium, where an instruction is stored on the readable storage medium. When the instruction is executed by a computer, the functions according to any one of the foregoing method embodiments are implemented.

According to the present application, there is further provided a computer program product. When the computer program product is executed by a computer, the functions according to any one of the foregoing method embodiments are implemented.

All or some of the foregoing embodiments may be implemented by using software, hardware, firmware, or any combination of them. When software is used to implement the embodiments, all or some of the embodiments may be implemented in a form of a computer program product. The computer program product includes one or more computer programs. When the computer program is loaded and executed on a computer, the procedures or functions according to the embodiments of the present application are all or partially generated. The computer may be a general-purpose computer, a dedicated computer, a computer network, or another programmable apparatus. The computer program may be stored in a computer-readable storage medium or transmitted from one computer-readable storage medium to another computer-readable storage medium. For example, the computer program may be transmitted from a website, computer, server, or data center to another website, computer, server, or data center in a wired (for example, a coaxial cable, an optical fiber, a digital subscriber line (DSL)), or a wireless (for example, infrared, wireless, microwave, or the like). The computer-readable storage medium may be any usable medium accessible by a computer, or a data storage device, such as a server or a data center, integrating one or more usable medium. The usable medium may be a magnetic medium (for example, a floppy disk, a hard disk, or a magnetic tape), an optical medium (for example, a high-density digital video disk (DVD)), a semiconductor medium (for example, a solid state disk (SSD)), or the like.

According to the present disclosure, there is provided a method for triggering TAR, an apparatus, a device, and a storage medium, to solve the technical problem in the related art that TAP cannot be successfully triggered due to the fact that some concepts are not clearly defined.

In a first aspect, according to some embodiments of the present disclosure, there is provided a method for triggering TAR, where the method is performed by a terminal device, and includes:

in response to a high layer of the terminal device initially configuring or reconfiguring a TA threshold, determining whether the terminal device reports TAR from a specific moment to a current moment; and

in response to determining that the terminal device does not report TAR from the specific moment to the current moment, triggering TAR.

In the present disclosure, there is provided a method for triggering TAR. When a high layer of a terminal device initially configures or reconfigures a TA threshold, the terminal device determines whether it reports TAR from a specific moment to a current moment; and if the terminal device does not report TAR from the specific moment to the current moment, the terminal device triggers TAR. Among them, the specific moment is a moment that is clearly defined in advance. It can be seen that, the method of the present disclosure clearly defines the specific time period for which it is determined whether TAR has been reported, so that there is no problem of conceptual fuzziness, and TAR can be ensured to be successfully triggered.

In some embodiments, the specific moment includes at least one of:

a moment at which the terminal device recently sends an uplink transmission carrying a radio resource control early data request message;

a moment at which the terminal device recently sends an uplink transmission carrying a radio resource control connection resume request message;

a moment at which the terminal device recently sends an uplink transmission carrying a radio resource control connection request message;

a moment at which the terminal device recently sends an uplink transmission carrying a radio resource control connection reestablishment request message;

a moment at which the terminal device recently sends an uplink transmission carrying a radio resource control connection reconfiguration complete message;

a moment at which the terminal device recently sends an uplink transmission carrying a radio resource control setup request message;

a moment at which the terminal device recently sends an uplink transmission carrying a radio resource control resume request message;

a moment at which the terminal device recently sends an uplink transmission carrying a radio resource control resume request 1 message;

a moment at which the terminal device recently sends an uplink transmission carrying a radio resource control reestablishment request message; or

a moment at which the terminal device recently sends an uplink transmission carrying a radio resource control reconfiguration complete message.

In some embodiments, the specific moment includes at least one of:

if a current connection of the terminal device is triggered by a preconfigured uplink resource (PUR) fallback, the specific moment is a moment at which the terminal device recently sends an uplink transmission carrying a radio resource control early data request message;

if a current connection of the terminal device is triggered by a PUR fallback, the specific moment is a moment at which the terminal device recently sends an uplink transmission carrying a radio resource control connection resume request message;

if a current connection of the terminal device is triggered by an early data transmission (EDT) fallback, the specific moment is a moment at which the terminal device recently sends an uplink transmission carrying a radio resource control early data request message;

if a current connection of the terminal device is triggered by an EDT fallback, the specific moment is a moment at which the terminal device recently sends an uplink transmission carrying a radio resource control connection resume request message;

if a current connection of the terminal device is triggered by a connection establishment procedure, the specific moment is a moment at which the terminal device recently sends an uplink transmission carrying a radio resource control connection request message;

if a current connection of the terminal device is triggered by a connection establishment procedure, the specific moment is a moment at which the terminal device recently sends an uplink transmission carrying a radio resource control setup request message;

if a current connection of the terminal device is triggered by a connection resume procedure, the specific moment is a moment at which the terminal device recently sends an uplink transmission carrying a radio resource control connection resume request message;

if a current connection of the terminal device is triggered by a connection resume procedure, the specific moment is a moment at which the terminal device recently sends an uplink transmission carrying a radio resource control resume request message;

if a current connection of the terminal device is triggered by a connection resume procedure, the specific moment is a moment at which the terminal device recently sends an uplink transmission carrying a radio resource control resume request 1 message;

if a current connection of the terminal device is triggered by a connection reestablishment procedure, the specific moment is a moment at which the terminal device recently sends an uplink transmission carrying a radio resource control connection reestablishment request message;

if a current connection of the terminal device is triggered by a connection reestablishment process, the specific moment is a moment at which the terminal device recently sends an uplink transmission carrying a radio resource control reestablishment request message;

if a current connection of the terminal device is triggered by a handover procedure, the specific moment is a moment at which the terminal device recently sends an uplink transmission carrying a radio resource control connection reconfiguration complete message;

if a current connection of the terminal device is triggered by a handover procedure, the specific moment is a moment at which the terminal device recently sends an uplink transmission carrying a radio resource control reconfiguration complete message;

if a current connection of the terminal device is triggered by a small data transmission (SDT), the specific moment is a moment at which the terminal device recently sends an uplink transmission carrying a radio resource control connection resume request message;

if a current connection of the terminal device is triggered by an SDT, the specific moment is a moment at which the terminal device recently sends an uplink transmission carrying a radio resource control resume request message; or

if a current connection of the terminal device is triggered by an SDT, the specific moment is a moment at which the terminal device recently sends an uplink transmission carrying a radio resource control resume request 1 message.

In some embodiments, the moment at which the terminal device recently sends the uplink transmission is a start moment of the uplink transmission.

In some embodiments, the specific moment includes at least one of:

if a random access procedure of a current connection of the terminal device is a 4-step random access procedure, the specific moment is a moment at which the terminal device sends an msg1;

if a random access procedure of a current connection of the terminal device is a 4-step random access procedure, the specific moment is a moment at which the terminal device sends an msg3; or

if a random access procedure of the current connection of the terminal device is a 2-step random access procedure, the specific moment is a moment at which the terminal device sends an msgA.

In some embodiments, the method further includes:

reporting the TAR to a network device.

In some embodiments, the high layer of the terminal device is an RRC layer.

In a second aspect, according to some embodiment of the present disclosure, there is provided a method for triggering TAR, where the method is performed by a network device, and includes:

receiving TAR reported by a terminal device.

In a third aspect, according to some embodiment of the present disclosure, there is provided a communication apparatus, where the apparatus is configured in a network device, and includes:

a processing module, configured to determine whether the terminal device reports TAR from a specific moment to a current moment in response to a high layer of the terminal device initially configuring or reconfiguring a TA threshold;

where the processing module is further configured to trigger TAR in response to determining that the terminal device does not reporting the TAR from the specific moment to the current moment.

In a fourth aspect, according to some embodiment of the present disclosure, there is provided a communication apparatus, where the apparatus is configured in a terminal device, and includes:

a transceiving module, configured to receive TAR reported by the terminal device.

In a fifth aspect, according to some embodiment of the present disclosure, there is provided a communication apparatus, where the communication apparatus includes a processor, and when the processor invokes a computer program in a memory, the method according to the first aspect is performed.

In a sixth aspect, according to some embodiment of the present disclosure, there is provided a communication apparatus, where the communication apparatus includes a processor, and when the processor invokes a computer program in a memory, the method according to the second aspect is performed.

In a seventh aspect, according to some embodiment of the present disclosure, there is provided a communication apparatus, where the communication apparatus includes a processor and a memory, the memory stores a computer program, and the processor executes the computer program stored in the memory to cause the communication apparatus to perform the method according to the first aspect.

In an eighth aspect, according to some embodiment of the present disclosure, there is provided a communication apparatus, where the communication apparatus includes a processor and a memory, the memory stores a computer program, and the processor executes the computer program stored in the memory to cause the communication apparatus to perform the method according to the second aspect.

In a ninth aspect, according to some embodiment of the present disclosure, there is provided a communication apparatus including a processor and an interface circuit, where the interface circuit is configured to receive a code instruction and transmit the code instruction to the processor, and the processor is configured to run the code instruction to cause the apparatus to perform the method according to the first aspect.

In a tenth aspect, according to some embodiment of the present disclosure, there is provided a communication apparatus including a processor and an interface circuit, where the interface circuit is configured to receive a code instruction and transmit the code instruction to the processor, and the processor is configured to run the code instruction to cause the apparatus to perform the method according to the second aspect.

In an eleventh aspect, according to some embodiment of the present disclosure, there is provided a communication system, where, the system includes the communication apparatus according to the third aspect and the communication apparatus according to the fourth aspect, or the system includes the communication apparatus according to the fifth aspect and the communication apparatus according to the sixth aspect, or the system includes the communication apparatus according to the seventh aspect and the communication apparatus according to the eighth aspect, or the system includes the communication apparatus according to the ninth aspect and the communication apparatus according to the tenth aspect.

In a twelfth aspect, according to some embodiment of the present disclosure, there is provided a computer-readable storage medium configured for storing an instruction used by the network device and/or the terminal device; when the instruction is executed, the terminal device is caused to perform the method according to the first aspect, and/or, the network device is caused to perform the method according to the second aspect.

In a thirteenth aspect, according to the present disclosure, there is provided a computer program product including a computer program, and when the computer program product runs on a computer, the computer is caused to perform the method according to any one of the first aspect to the second aspect.

In a fourteenth aspect, according to the present disclosure, there is provided a chip system, where the chip system includes at least one processor and an interface, and is configured to support a terminal device to implement functions involved in the method according to the first aspect, and/or to support a network device to implement functions involved in the method according to the second aspect, for example, to determine or process at least one of data or information involved in the foregoing method. In a possible design, the chip system further includes a memory, and the memory is configured for storing a computer program and data that are necessary for a source secondary node. The chip system may include a chip, or may include a chip and another discrete component.

In a fifteenth aspect, according to the present disclosure, there is provided a computer program; when the computer program runs on a computer, the computer is caused to perform the method according to any one of the first aspect to the second aspect.

Those of ordinary skill in the art may understand that various numerical numbers, such as first and second, involved in the present application are merely used to distinguish for ease of description, and are not used to limit the scope of the embodiments of the present application, which also do not indicate a sequence.

“At least one” in the present application may also be described as one or more, and the plurality may be two, three, four, or more, which is not limited in the present application. In the embodiments of the present application, for a kind of technical features, technical features in this kind of technical features are distinguished by using “first”, “second”, “third”, “A”, “B”, “C”, and “D”, etc. There is no sequence of order or sequence of size among the technical features described by using “first”, “second”, “third”, “A”, “B”, “C”, and “D”.

The correspondence shown in the tables in the present application may be configured, or may be predefined. The value of the information in each table is merely an example, and may be configured as another value, which is not limited in the present application. When the correspondence between the information and each parameter is configured, it does not need to configure all the correspondences shown in the tables must. For example, in the table in the present application, the correspondences shown in some rows may also not be configured. For another example, appropriate deformation adjustment may be performed based on the foregoing table, for example, splitting, merging, or the like. The names of the parameters in the foregoing tables may also be other names that may be understood by using a communication apparatus, and the values or representation manners of the parameters may also be other values or other representation manners that may be understood by using a communication apparatus. When the foregoing tables are implemented, other data structures may also be used. For example, an array, a queue, a container, a stack, a linear table, a pointer, a linked list, a tree, a graph, a structure, a class, a heap, a hash table, or the like may be used.

Predefinition in the present application may be understood as definition, pre-definition, storage, pre-storage, pre-negotiation, pre-configuration, curing, or pre-firing.

Those of ordinary skill in the art may be aware that, the example units and algorithm steps that are described in combination with the embodiments disclosed in this specification, may be implemented by electronic hardware or a combination of computer software and electronic hardware. Whether the functions are performed by hardware or software depends on particular applications and design constraint conditions of the technical solutions. Those skilled in the art may use different methods to implement the described functions for each particular application, but it should not be considered that the implementation goes beyond the scope of the present application.

It may be clearly understood by those skilled in the art that, for the purpose of convenient and brief description, for a detailed working process of the foregoing system, apparatus, and unit, reference may be made to a corresponding process in the foregoing method embodiments, and details are not described here again.

The foregoing descriptions are merely specific implementations of the present application, but the protection scope of the present application is not limited to this. Any changes or substitutions that may be easily conceived of by those skilled in the art within the technical scope disclosed in the present application, should be all covered within the scope of protection of the present application. Therefore, the protection scope of the present application shall be subject to the protection scope of the claim.

1. A method for triggering timing advance reporting (TAR), performed by a terminal device, and comprising:
in response to a high layer of the terminal device initially configuring or reconfiguring a TA threshold, determining whether the terminal device reports TAR from a specific moment to a current moment; and
in response to determining that the terminal device does not report TAR from the specific moment to the current moment, triggering TAR.

2. The method according to claim 1, wherein the specific moment comprises at least one of:
a moment at which the terminal device recently sends an uplink transmission carrying a radio resource control early data request message;
a moment at which the terminal device recently sends an uplink transmission carrying a radio resource control connection resume request message;
a moment at which the terminal device recently sends an uplink transmission carrying a radio resource control connection request message;
a moment at which the terminal device recently sends an uplink transmission carrying a radio resource control connection reestablishment request message;
a moment at which the terminal device recently sends an uplink transmission carrying a radio resource control connection reconfiguration complete message;
a moment at which the terminal device recently sends an uplink transmission carrying a radio resource control setup request message;
a moment at which the terminal device recently sends an uplink transmission carrying a radio resource control resume request message;
a moment at which the terminal device recently sends an uplink transmission carrying a radio resource control resume request 1 message;
a moment at which the terminal device recently sends an uplink transmission carrying a radio resource control reestablishment request message; or a moment at which the terminal device recently sends an uplink transmission carrying a radio resource control reconfiguration complete message.

3. The method according to claim 1, wherein the specific moment comprises at least one of:
in response to determining that a current connection of the terminal device is triggered by a preconfigured uplink resource (PUR) fallback, the specific moment is a moment at which the terminal device recently sends an uplink transmission carrying a radio resource control early data request message;
in response to determining that a current connection of the terminal device is triggered by a PUR fallback, the specific moment is a moment at which the terminal device recently sends an uplink transmission carrying a radio resource control connection resume request message;
in response to determining that a current connection of the terminal device is triggered by an early data transmission (EDT) fallback, the specific moment is a moment at which the terminal device recently sends an uplink transmission carrying a radio resource control early data request message;
in response to determining that a current connection of the terminal device is triggered by an EDT fallback, the specific moment is a moment at which the terminal device recently sends an uplink transmission carrying a radio resource control connection resume request message;
in response to determining that a current connection of the terminal device is triggered by a connection establishment procedure, the specific moment is a moment at which the terminal device recently sends an uplink transmission carrying a radio resource control connection request message;
in response to determining that a current connection of the terminal device is triggered by a connection establishment procedure, the specific moment is a moment at which the terminal device recently sends an uplink transmission carrying a radio resource control setup request message;
in response to determining that a current connection of the terminal device is triggered by a connection resume procedure, the specific moment is a moment at which the terminal device recently sends an uplink transmission carrying a radio resource control connection resume request message;
in response to determining that a current connection of the terminal device is triggered by a connection resume procedure, the specific moment is a moment at which the terminal device recently sends an uplink transmission carrying a radio resource control resume request message;
in response to determining that a current connection of the terminal device is triggered by a connection resume procedure, the specific moment is a moment at which the terminal device recently sends an uplink transmission carrying a radio resource control resume request 1 message;
in response to determining that a current connection of the terminal device is triggered by a connection reestablishment procedure, the specific moment is a moment at which the terminal device recently sends an uplink transmission carrying a radio resource control connection reestablishment request message;
in response to determining that a current connection of the terminal device is triggered by a connection reestablishment process, the specific moment is a moment at which the terminal device recently sends an uplink transmission carrying a radio resource control reestablishment request message;
in response to determining that a current connection of the terminal device is triggered by a handover procedure, the specific moment is a moment at which the terminal device recently sends an uplink transmission carrying a radio resource control connection reconfiguration complete message;
in response to determining that a current connection of the terminal device is triggered by a handover procedure, the specific moment is a moment at which the terminal device recently sends an uplink transmission carrying a radio resource control reconfiguration complete message;
in response to determining that a current connection of the terminal device is triggered by a small data transmission (SDT), the specific moment is a moment at which the terminal device recently sends an uplink transmission carrying a radio resource control connection resume request message;
in response to determining that a current connection of the terminal device is triggered by an SDT, the specific moment is a moment at which the terminal device recently sends an uplink transmission carrying a radio resource control resume request message; or
in response to determining that a current connection of the terminal device is triggered by an SDT, the specific moment is a moment at which the terminal device recently sends an uplink transmission carrying a radio resource control resume request 1 message.

4. The method according to claim 2, wherein the moment at which the terminal device recently sends the uplink transmission is a start moment of the uplink transmission.

5. The method according to claim 1, wherein the specific moment comprises at least one of:
in response to determining that a random access procedure of a current connection of the terminal device is a 4-step random access procedure, the specific moment is a moment at which the terminal device sends an msg1;
in response to determining that a random access procedure of a current connection of the terminal device is a 4-step random access procedure, the specific moment is a moment at which the terminal device sends an msg3; or
in response to determining that a random access procedure of the current connection of the terminal device is a 2-step random access procedure, the specific moment is a moment at which the terminal device sends an msgA.

6. The method according to claim 1, further comprising:
reporting the TAR to a network device.

7. The method according to claim 1, wherein the high layer of the terminal device is an RRC layer.

8. A method for triggering TAR, performed by a network device, and comprising:
receiving TAR reported by a terminal device;
wherein the TAR is triggered by the terminal device in response to determining that a high layer of the terminal device initially configures or reconfigures a TA threshold and that the terminal device does not report TAR from a specific moment to a current moment.

9-10. (canceled)

11. A communication apparatus, comprising a processor and a memory, wherein the memory stores a computer program, and the processor executes the computer program stored in the memory to enable the communication apparatus to perform a method for triggering TAR, comprising:
in response to a high layer of the terminal device initially configuring or reconfiguring a TA threshold, determining whether the terminal device reports TAR from a specific moment to a current moment; and
in response to determining that the terminal device does not report TAR from the specific moment to the current moment, triggering TAR.

12. A communication apparatus, comprising a processor and an interface circuit, wherein,
the interface circuit is configured to receive a code instruction and transmit the code instruction to the processor; and
the processor is configured to run the code instruction to perform the method according to claim 1.

13. A non-transitory computer-readable storage medium, configured for storing an instruction that, when executed, enables the method according to claim 1 to be implemented.

14. The method according to claim 2, wherein the specific moment comprises at least one of:
in response to determining that a current connection of the terminal device is triggered by a preconfigured uplink resource (PUR) fallback, the specific moment is a moment at which the terminal device recently sends an uplink transmission carrying a radio resource control early data request message;
in response to determining that a current connection of the terminal device is triggered by a PUR fallback, the specific moment is a moment at which the terminal device recently sends an uplink transmission carrying a radio resource control connection resume request message;
in response to determining that a current connection of the terminal device is triggered by an early data transmission (EDT) fallback, the specific moment is a moment at which the terminal device recently sends an uplink transmission carrying a radio resource control early data request message;
in response to determining that a current connection of the terminal device is triggered by an EDT fallback, the specific moment is a moment at which the terminal device recently sends an uplink transmission carrying a radio resource control connection resume request message;
in response to determining that a current connection of the terminal device is triggered by a connection establishment procedure, the specific moment is a moment at which the terminal device recently sends an uplink transmission carrying a radio resource control connection request message;
in response to determining that a current connection of the terminal device is triggered by a connection establishment procedure, the specific moment is a moment at which the terminal device recently sends an uplink transmission carrying a radio resource control setup request message;
in response to determining that a current connection of the terminal device is triggered by a connection resume procedure, the specific moment is a moment at which the terminal device recently sends an uplink transmission carrying a radio resource control connection resume request message;
in response to determining that a current connection of the terminal device is triggered by a connection resume procedure, the specific moment is a moment at which the terminal device recently sends an uplink transmission carrying a radio resource control resume request message;
in response to determining that a current connection of the terminal device is triggered by a connection resume procedure, the specific moment is a moment at which the terminal device recently sends an uplink transmission carrying a radio resource control resume request 1 message;
in response to determining that a current connection of the terminal device is triggered by a connection reestablishment procedure, the specific moment is a moment at which the terminal device recently sends an uplink transmission carrying a radio resource control connection reestablishment request message;
in response to determining that a current connection of the terminal device is triggered by a connection reestablishment process, the specific moment is a moment at which the terminal device recently sends an uplink transmission carrying a radio resource control reestablishment request message;
in response to determining that a current connection of the terminal device is triggered by a handover procedure, the specific moment is a moment at which the terminal device recently sends an uplink transmission carrying a radio resource control connection reconfiguration complete message;
in response to determining that a current connection of the terminal device is triggered by a handover procedure, the specific moment is a moment at which the terminal device recently sends an uplink transmission carrying a radio resource control reconfiguration complete message;
in response to determining that a current connection of the terminal device is triggered by a small data transmission (SDT), the specific moment is a moment at which the terminal device recently sends an uplink transmission carrying a radio resource control connection resume request message;
in response to determining that a current connection of the terminal device is triggered by an SDT, the specific moment is a moment at which the terminal device recently sends an uplink transmission carrying a radio resource control resume request message; or
in response to determining that a current connection of the terminal device is triggered by an SDT, the specific moment is a moment at which the terminal device recently sends an uplink transmission carrying a radio resource control resume request 1 message.

15. The method according to claim 3, wherein the moment at which the terminal device recently sends the uplink transmission is a start moment of the uplink transmission.

16. The method according to claim 8, wherein the specific moment comprises at least one of:
a moment at which the terminal device recently sends an uplink transmission carrying a radio resource control early data request message;
a moment at which the terminal device recently sends an uplink transmission carrying a radio resource control connection resume request message;
a moment at which the terminal device recently sends an uplink transmission carrying a radio resource control connection request message;
a moment at which the terminal device recently sends an uplink transmission carrying a radio resource control connection reestablishment request message;
a moment at which the terminal device recently sends an uplink transmission carrying a radio resource control connection reconfiguration complete message;
a moment at which the terminal device recently sends an uplink transmission carrying a radio resource control setup request message;
a moment at which the terminal device recently sends an uplink transmission carrying a radio resource control resume request message;
a moment at which the terminal device recently sends an uplink transmission carrying a radio resource control resume request I message;
a moment at which the terminal device recently sends an uplink transmission carrying a radio resource control reestablishment request message; or
a moment at which the terminal device recently sends an uplink transmission carrying a radio resource control reconfiguration complete message.

17. The method according to claim 8, wherein the specific moment comprises at least one of:
in response to determining that a current connection of the terminal device is triggered by a preconfigured uplink resource (PUR) fallback, the specific moment is a moment at which the terminal device recently sends an uplink transmission carrying a radio resource control early data request message;
in response to determining that a current connection of the terminal device is triggered by a PUR fallback, the specific moment is a moment at which the terminal device recently sends an uplink transmission carrying a radio resource control connection resume request message;
in response to determining that a current connection of the terminal device is triggered by an early data transmission (EDT) fallback, the specific moment is a moment at which the terminal device recently sends an uplink transmission carrying a radio resource control early data request message;
in response to determining that a current connection of the terminal device is triggered by an EDT fallback, the specific moment is a moment at which the terminal device recently sends an uplink transmission carrying a radio resource control connection resume request message;
in response to determining that a current connection of the terminal device is triggered by a connection establishment procedure, the specific moment is a moment at which the terminal device recently sends an uplink transmission carrying a radio resource control connection request message;
in response to determining that a current connection of the terminal device is triggered by a connection establishment procedure, the specific moment is a moment at which the terminal device recently sends an uplink transmission carrying a radio resource control setup request message;
in response to determining that a current connection of the terminal device is triggered by a connection resume procedure, the specific moment is a moment at which the terminal device recently sends an uplink transmission carrying a radio resource control connection resume request message;
in response to determining that a current connection of the terminal device is triggered by a connection resume procedure, the specific moment is a moment at which the terminal device recently sends an uplink transmission carrying a radio resource control resume request message;
in response to determining that a current connection of the terminal device is triggered by a connection resume procedure, the specific moment is a moment at which the terminal device recently sends an uplink transmission carrying a radio resource control resume request 1 message;
in response to determining that a current connection of the terminal device is triggered by a connection reestablishment procedure, the specific moment is a moment at which the terminal device recently sends an uplink transmission carrying a radio resource control connection reestablishment request message;
in response to determining that a current connection of the terminal device is triggered by a connection reestablishment process, the specific moment is a moment at which the terminal device recently sends an uplink transmission carrying a radio resource control reestablishment request message;
in response to determining that a current connection of the terminal device is triggered by a handover procedure, the specific moment is a moment at which the terminal device recently sends an uplink transmission carrying a radio resource control connection reconfiguration complete message;
in response to determining that a current connection of the terminal device is triggered by a handover procedure, the specific moment is a moment at which the terminal device recently sends an uplink transmission carrying a radio resource control reconfiguration complete message;
in response to determining that a current connection of the terminal device is triggered by a small data transmission (SDT), the specific moment is a moment at which the terminal device recently sends an uplink transmission carrying a radio resource control connection resume request message;
in response to determining that a current connection of the terminal device is triggered by an SDT, the specific moment is a moment at which the terminal device recently sends an uplink transmission carrying a radio resource control resume request message; or
in response to determining that a current connection of the terminal device is triggered by an SDT, the specific moment is a moment at which the terminal device recently sends an uplink transmission carrying a radio resource control resume request 1 message.

18. The method according to claim 17, wherein the moment at which the terminal device recently sends the uplink transmission is a start moment of the uplink transmission.

19. The method according to claim 8, wherein the specific moment comprises at least one of:
in response to determining that a random access procedure of a current connection of the terminal device is a 4-step random access procedure, the specific moment is a moment at which the terminal device sends an msg1;
in response to determining that a random access procedure of a current connection of the terminal device is a 4-step random access procedure, the specific moment is a moment at which the terminal device sends an msg3; or
in response to determining that a random access procedure of the current connection of the terminal device is a 2-step random access procedure, the specific moment is a moment at which the terminal device sends an msgA.

20. A communication apparatus, comprising a processor and a memory, wherein the memory stores a computer program, and the processor executes the computer program stored in the memory to enable the communication apparatus to perform the method according to claim 8.

21. A communication apparatus, comprising a processor and an interface circuit, wherein,
the interface circuit is configured to receive a code instruction and transmit the code instruction to the processor; and
the processor is configured to run the code instruction to perform the method according to claim 8.

22. A non-transitory computer-readable storage medium, configured for storing an instruction that, when executed, enables the method according to claim 8 to be implemented.
